(19) United States
(12) Patent Application Publication
(10) Pub. No.: US 2018/0335095 A1
(43) Pub. Date: Nov. 22, 2018

(54) Two-Way Output Reverse-Torque Clutch

(71) Applicants: David R. Hall, Provo, UT (US); Jerome Miles, Spanish Fork, UT (US); Andrew Priddis, Mapleton, UT (US); Daniel Madsen, Vineyard, UT (US); Benjamin Taylor, Provo, UT (US); Jackson Priddis, Orem, UT (US); Jedediah Knight, Provo, UT (US); Joe Fox, Spanish Fork, UT (US)

(72) Inventors: David R. Hall, Provo, UT (US); Jerome Miles, Spanish Fork, UT (US); Andrew Priddis, Mapleton, UT (US); Daniel Madsen, Vineyard, UT (US); Benjamin Taylor, Provo, UT (US); Jackson Priddis, Orem, UT (US); Jedediah Knight, Provo, UT (US); Joe Fox, Spanish Fork, UT (US)

(21) Appl. No.: 15/596,639

(22) Filed: May 16, 2017

(51) Int. Cl. F16D 43/20; F16D 7/00

(52) U.S. Cl. CPC F16D 43/20; F16D 7/00

(57) ABSTRACT

Embodiments of a two-way output reverse-torque clutch described herein may include a torque input having a segmented race, a pin removably disposed adjacent to, and between, at least two segmented race segments, a torque output rotatably disposed within the segmented race, and an outer race encircling the segmented race. The torque output may include a cam surface with an interference point corresponding to at least one of the one or more pins. The cam surface may have an interference point. The outer race may be in slideable contact with the segmented race. A torque exerted directly on the output may force the interference point against the pin, wedging the pin between the interference point and the outer race and preventing torque from being transmitted to the input from the output. The clutch may prevent torque from being transmitted to the torque input from the torque output with one pin.

### TECHNICAL FIELD

This invention relates generally to smart devices and more specifically to roll-up and/or winding devices.

### BACKGROUND

With the proliferation of the Internet of Things, and more specifically of smart home and/or remotely-controlled devices, consumers and manufacturers are facing new challenges. One such challenge is making devices more compact, while still retaining robust functionality. An example of such a device may be found in U.S. Patent Publication Number 2015/0284221 to David Hall et al. entitled “Compact Motorized Lifting Device.” In general, a problem with motorized devices that wind/roll-up components is preventing reverse-torque from unwinding/unrolling the components. Some reverse clutches have been designed that prevent reverse-torque. However, such devices may be complex. Reducing complexity, such as by reducing the number of required parts, may help in streamlining manufacturing processes and simplifying maintenance. Thus, there is room for improvement in the art.

### SUMMARY OF THE INVENTION

Embodiments of a two-way output reverse-torque clutch are described herein that address some of the issues described above in the Background. The clutch may include a torque input, one or more pins, a torque output, and an outer race. The clutch may be two-way output and reverse-torque operable with as few as one pin. The torque input may include a segmented race. At least one of the one or more pins may be removably disposed adjacent to, and between, at least two segmented race segments. The torque output may be rotatably disposed within the segmented race. The torque output may include a cam surface corresponding to at least one of the one or more pins. The cam surface may have an interference point. The interference point may comprise a material harder than the pin. The interference point may comprise a hard material selected from the group consisting of tungsten carbide, cubic boron nitride, titanium carbide, titanium nitride, diamond, and diamond like carbon. The outer race may encircle the segmented race. The outer race may be in slideable contact with the segmented race. A torque exerted on the input may press the pins against the cam surface and rotate the output and the input with respect to the outer race. A torque exerted directly on the output may force the interference point against the pin, wedging the pin between the interference point and the outer race and preventing torque from being transmitted to the input from the output. The clutch may prevent torque from being transmitted to the torque input from the torque output with as few as one pin.

In various embodiments, the torque input may further include a base plate. The segmented race may be connected to, and/or may extend from, the base plate. For example, the base plate and the segmented race may be monolithic. The pins, the torque output, and/or the outer race may rest against the base plate. The outer race may include a backing forming a cup enclosing the segmented race and/or the base plate. One or more openings may be formed through the backing. The openings may correspond to couplers that pass through the openings and that may couple the outer race to a motor housing.

In various embodiments, the torque input may further include a hollow input shaft extending through the torque input. The torque input may further include a base plate disposed between the input shaft and the segmented race. The input shaft and the segmented race may extend from the base plate in opposite directions. The input shaft may have a narrower diameter than the base plate, the segmented race, or both. The torque output may include a hollow output shaft extending through the torque output. The input shaft and the output shaft may be concentric. The input shaft may extend through the output shaft.

In various embodiments, the pins may include one or more grooves. The outer race and/or the cam surface may include one or more runners corresponding to, and disposed in, the grooves. Alternatively, in various embodiments, the outer race and/or the cam surface may include one or more grooves. The pins may include one or more runners corresponding to, and disposed in, the grooves.

In various embodiments, the output may have a thickness greater than a thickness of the input.

### BRIEF DESCRIPTION OF THE DRAWINGS

A more particular description of the apparatus summarized above is made below by reference to specific embodiments. Several embodiments are depicted in drawings included with this application, in which:

FIGS. 1A-B depict various implementations of a two-way output reverse-torque clutch.;

FIG. 2 depicts an exploded view of a winch incorporating a two-way output reverse-torque clutch;

FIGS. 3A-B depict exploded views of a roll-up wall assembly incorporating a two-way output reverse-torque clutch;

FIG. 4 depicts an exploded view of one two-way output reverse-torque clutch assembly embodiment;

FIGS. 5A-C depict top and cross-sectional views of another two-way output reverse-torque clutch assembly embodiment;

FIGS. 6A-D depict exploded, top and cross-sectional views of a two-way output reverse-torque clutch assembly embodiment;

FIGS. 7A-D depict exploded, top and cross-sectional views of another two-way output reverse-torque clutch assembly embodiment; and

FIGS. 8A-D depict exploded, top and cross-sectional views of yet another two-way output reverse-torque clutch assembly embodiment.

### DETAILED DESCRIPTION

A detailed description of embodiments of an apparatus is provided below by example, with reference to embodiments in the appended figures. Those of skill in the art will recognize that the features of the apparatus as described by example in the figures below could be arranged and designed in a variety of different configurations without departing from the scope of the claims. Thus, the detailed description below and the depictions of embodiments in the figures is representative of the claimed invention, and is not intended to limit the scope of the claims.

Embodiments of a two-way output reverse-torque clutch are described herein. The clutch may include a torque input, a pin, a torque output, and an outer race. The clutch may be two-way output and reverse-torque operable with as few as one pin. The torque input may include a segmented race. The pin may be removably disposed adjacent to, and between, at least two segmented race segments. The torque output may be rotatably disposed within the segmented race. The torque output may include a cam surface corresponding to the pin. The cam surface may have an interference point. The outer race may encircle the segmented race. The outer race may be in slideable contact with the segmented race. A torque exerted on the input may press the pin against the cam surface and rotate the output and the input with respect to the outer race. A torque exerted directly on the output may force the interference point against the pin, wedging the pin between the interference point and the outer race and preventing torque from being transmitted to the input from the output. The clutch may prevent torque from being transmitted to the torque input from the torque output with as few as one pin.

In various embodiments, the torque input may further include a base plate. The segmented race may be connected to, and/or may extend from, the base plate. For example, the base plate and the segmented race may be monolithic. The pin, the torque output, and/or the outer race may rest against the base plate. The outer race may include a backing forming a cup enclosing the segmented race and/or the base plate. One or more openings may be formed through the backing. The openings may correspond to couplers that pass through the openings and that may couple the outer race to a motor housing.

In various embodiments, the torque input may further include a hollow input shaft extending through the torque input. The torque input may further include a base plate disposed between the input shaft and the segmented race. The input shaft and the segmented race may extend from the base plate in opposite directions. The input shaft may have a narrower diameter than the base plate, the segmented race, or both. The torque output may include a hollow output shaft extending through the torque output. The input shaft and the output shaft may be concentric. The input shaft may extend through the output shaft.

In various embodiments, the pin may include one or more grooves. The outer race and/or the cam surface may include one or more runners corresponding to, and disposed in, the grooves. Alternatively, in various embodiments, the outer race and/or the cam surface may include one or more grooves. The pin may include one or more runners corresponding to, and disposed in, the grooves.

In various embodiments, the output may have a thickness greater than a thickness of the input.

The clutch may be a two-way output clutch in that a rotational input in either direction is transmitted via the output to a rotatable element, such as a gear set, rod, ring transmission, or drum. The clutch may be a two-way output reverse-torque clutch in that rotational input via the torque output is not transmitted to the torque input. In other words, “reverse-torque clutch” refers to the apparatus's ability to prevent transmission of torque from the torque output to the torque input.

The clutch may be implemented in any of a variety of motorized winding devices. Such devices may include lifters, winches, hose-winding devices, spooling devices, roll-up walls, roll-up shades, and others. In various embodiments, the motor may be disposed within a drum onto which an element, such as a string, cord, wire, hose, and/or panel, is wound. Examples of such devices are described in U.S. Patent Publication Number 2015/0284221 to David Hall et al., entitled “Compact Motorized Lifting Device”; U.S. patent application Ser. No. 15/426,556 by David Hall et al. for “Compact Inflator”; U.S. patent application Ser. No. 15/495,118 by David Hall et al. for “Spring-Tensioned Roll-Up Wall”; U.S. patent application Ser. No. 15/241,589 by David Hall et al. for “Winch with Impact Transmission”; and U.S. patent application Ser. No. 15/458,453 by David Hall et al. for “Motorized Roll-Up Window Shade.”

The torque input may, generally, receive a rotor of a motor to transmit torque from the motor to, for example, a drum. The torque input may be comprised of any of a variety of materials suitable for such a task. Such may be true of each of the pin, torque output, and outer race, in addition to other components integrated with the clutch. Accordingly, such components may be comprised of various plastics, metals, or combinations thereof. For example, such components may be comprised of aluminum, aluminum alloy, steel, carbon-steel, titanium, PVC, ABS, nylon, Teflon, carbon fiber, silicone, or combinations thereof. The material composition of the clutch components may depend on the particular implementation and anticipated maximum stresses on the clutch. A small, light-weight shade, such as one that weighs approximately five pounds, may incorporate a plastic clutch. A heavy-duty winch may require a steel or carbon-steel clutch. Various industrial implementations may require a titanium clutch.

The torque input may include a segmented race. The segmented race may be interconnected at a base of the torque input. The segmentation of the race may be uniform or non-uniform. For example, the race may include four segments, each segment forming a sixth of a hollowed cylinder. A trough may be provided between each segment to accommodate portions of the torque output and/or the pin. In one embodiment, partially-cylindrical fins may extend from the torque input into a first set of opposing troughs, and pin may be disposed in a second set of opposing troughs. In one embodiment, the torque input race segments are connected at one end such that the segments are monolithic, and separated at a second end such that a trough is disposed between the segments. A pin may be disposed in the trough.

The torque input may include a base plate. The base plate may be cylindrical, and may have a diameter greater than, equal to, or less than the segmented race. The segmented race may be directly connected to, and extend from, the base plate. For example, the base plate and the segmented race may be monolithic. The base plate may provide means for securing various components of the clutch together. For example, the pin, torque output, outer race, or combinations thereof, may rest against the base plate. Such components may be pinned between the base plate and, for example, a transmission ring that transmits torque from the torque output to a drum.

The torque input may include a hollow input shaft extending through the torque input. The hollow shaft may receive a rotor from a motor that transmits torque from the motor to the torque input. The hollow shaft may have an interior shape profile complementary to an external shape profile of the rotor. The base plate may be disposed between the input shaft and the segmented race. The interior shape profile may extend through the base plate and terminate before the segmented race. The hollow input shaft may open to an inner area of the segmented race. The hollow shaft and the segmented race may extend from the base plate in opposite directions. The hollow shaft may have a narrower diameter than the base plate, the segmented race, or both. Alternatively, the hollow shaft may have wider diameter than the base plate, the segmented race, or both. The advantages of such configurations may include enabling use of a planetary gear drive system and a direct drive system simultaneously. The planet gears may extend partially from the shaft and may selectively engage with a ring gear. The ring gear may fix the planet gears and enable rotation of the torque input.

The torque input may include a solid input shaft extending from the torque input. The solid shaft may insert into a hollow rotor of a motor or some other torque mechanism. The shaft may have an external shape corresponding to an internal shape of the hollow torque mechanism.

In various embodiments, the torque output may include a hollow or solid output shaft extending through or from the torque output. In some such embodiments, the input shaft and the output shaft may be concentric. The input shaft may extend through the output shaft. For example, the input shaft may include a groove at an end of the input shaft extending past the output shaft. The input shaft may further extend through a transmission ring that mates with the torque output to transmit torque to a drum. A lock ring may set into the groove in the input shaft and may prevent the transmission ring from sliding off the input shaft. Conversely, in some embodiments, the input shaft and the output shaft may be non-concentric, which may provide various mechanical advantages in particular implementations of the clutch. For example, the torque output may interface with a set of planetary gears that may transmit a higher torque to a drum. In various embodiments, the torque output may form one of the planet gears of the planetary gear set.

The pin may function to prevent reverse-torque exerted on the torque output, for example by a drum, from exerting a torque on the torque input and, in turn, a torque mechanism connected to the torque input, such as a motor. The pins may be, for example, cylindrical, spherical, or ellipsoidal. As used herein, “pin” refers to a function and/or status of the element, rather than a particular shape or dimensional proportionality of the element. For example, pin may mean that the element is pinned between two other elements and prevents movement of the elements with respect to each other.

The pin may be removably disposed adjacent to, and between, at least two segmented race segments, as described above. The pin may be enclosed by the segmented race segments, the outer race, and the cam surface along at least two axes. A torque exerted on the torque output may press, or “pin,” the pin between the cam surface and the outer race. In this way, the pin may prevent rotation of the torque output with respect to the outer race. The cam surface may have a narrower diameter directly aligned with the pin than on either side of the pin. The space between the cam surface along the narrower diameter of the torque output, and the outer race, may have dimensions slightly larger than the pin, such as by 0.25% to 5%. The larger diameter of the torque output may form a space between the cam surface and the outer race slightly smaller than the pin, such as by 0.25% to 5%. Rotation of the torque output may accordingly force the cam surface against the pin, pressing the pin against the outer race, and preventing further rotation of the torque output with respect to the outer race. The pin may be secured between the cam surface and the outer race by friction and/or by ends of the segmented race segments.

Although a singular pin is referred to herein, the clutch may be configured to accommodate two or more pins. However, only one pin may be required to prevent torque from being transmitted from the torque output to the torque input. Accordingly, various two-pin embodiments are depicted in the FIGs. that inform those of skill in the art how the clutch may function with both a single pin and multiple pins.

Some embodiments may include multiple pins to increase the torque limit of the clutch. However, a fail-safe function of the various structures described herein, and depicted in the FIGs., is that the clutch is operable with as few as one pin. Thus, wear and/or breakage of all but one pin that makes all but one pin inoperable does not render the clutch inoperable for preventing torque from being transmitted to the torque input from the torque output.

Various features may be included that secure some or all of the clutch components together. In some embodiments, the pin may include one or more grooves. The grooves may extend around a circumference of the pin. The outer race and the cam surface may include one or more runners corresponding to, and disposed in, the grooves. Similarly, the outer race and the cam surface may include one or more grooves, and the pin may include one or more runners encompassing the pin. The runners may correspond to, and be disposed in, the grooves. The runners and grooves may prevent lateral movement of the outer race, the torque output, and/or the pin.

The torque output may be rotatably disposed within the segmented race. The torque output may be removeable from the segmented race or fixed to the segmented race. For the example, the segmented race and the torque output may include grooves and runners that fix the elements together. Fixing elements of the clutch together may provide the benefit of manufacturing and selling the clutch separately from the winding device, and may simplify integration of the clutch into various devices.

As described above, the torque output may include a hollow output shaft extending through the torque output. The output shaft may allow for a torque transmission rod to be inserted into the torque output. The output shaft may have an interior surface complementary to an external surface of the torque transmission rod. In some embodiments, the torque output may have a thickness greater than a thickness of the torque input. This may allow the torque input to interface directly with, for example, a torque transmission ring directly coupled to a drum. The torque transmission ring may include a shape in the ring complementary to, and fit to, the torque output.

The cam surface may include an interference point. The interference point may comprise a material harder than the pin. The interference point may comprise a hard material selected from the group consisting of tungsten carbide, cubic boron nitride, titanium carbide, titanium nitride, diamond, and diamond like carbon. For example, the torque input may resemble a cylinder with at least one flattened side. The cam surface may include the entire outer surface of the cylinder, including the flattened side, and the interference point may include the transition from the flat portion to the curved portion of the cam surface. In general, the interference point is a point along the cam surface where the thickness and/or diameter of the torque output changes, such that a depth of a space formed between the outer race and the cam surface decreases as the torque output rotates in the torque input.

The outer race may encircle the segmented race. The outer race may have an inner diameter such that the outer race forms slideable, frictional contact with the segmented race. A torque exerted on the input may press the pin against the cam surface and rotate the output and the input with respect to the outer race. However, a torque exerted on the output may press the pin between the cam surface and the outer race and prevent rotation of the output with respect to the outer race. In various embodiments, the outer race may include a backing that forms a cup. The outer race may enclose one or more of the torque input, the torque output, and the pin. One or more openings may be formed in the backing. The openings may correspond to couplers that pass through the openings and couple the outer race to, for example, a motor housing. Opposing the backing may be, for example, a torque transmission ring. The elements of the clutch may be pinned between the outer race backing and the torque transmission ring.

Various specific implementations and embodiments of the clutch described above are depicted in the appended drawings. Descriptions of those drawings are provided below.

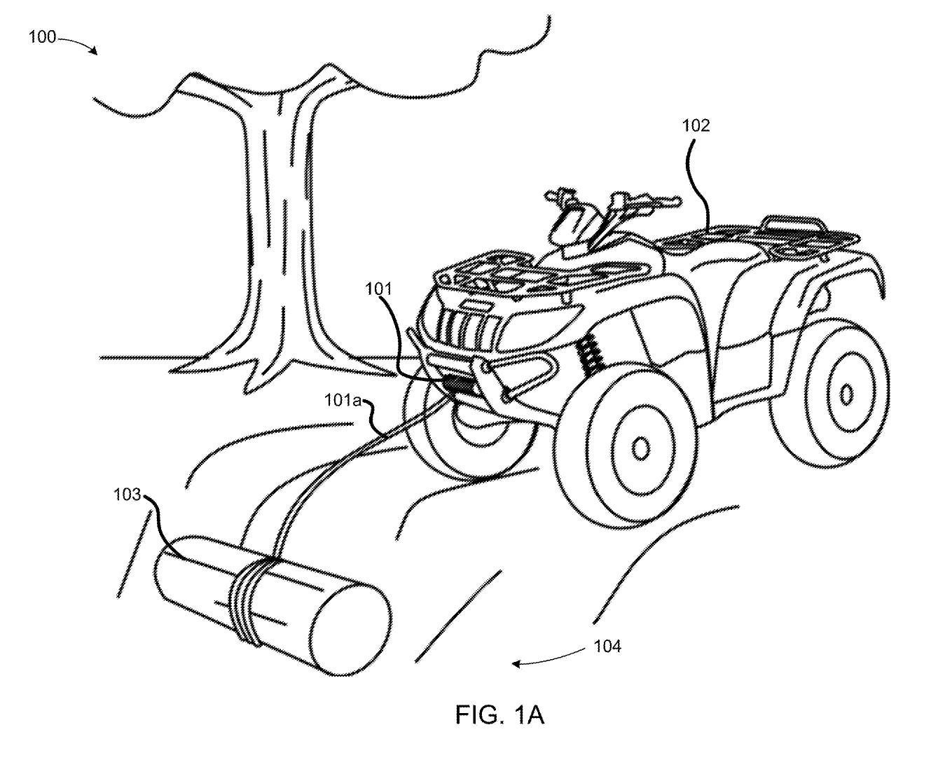

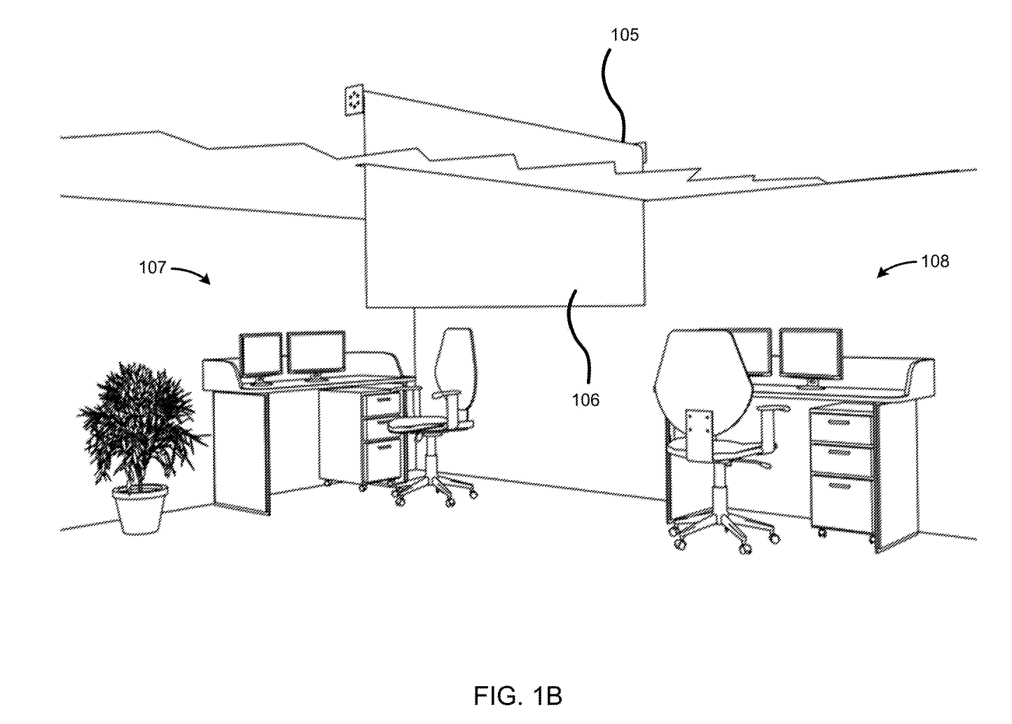

FIGS. 1A-B depict various implementations of a two-way output reverse-torque clutch. In FIG. 1A, the clutch is integrated into a winch 101, which in turn is mounted to an ATV 102. A winch line 101a extends from the winch 101 and is attached to a log 103 located downhill 104 from the ATV 102. The clutch inside the winch 101 prevents the weight of the log 103 from unraveling the winch line 101a when a motor inside the winch 101 is not operating. In FIG. 1B, the clutch is integrated into a tube 105 of a roll-up wall 106. Th wall 106 may separate work spaces 107, 108. The clutch may prevent the wall 106 from unraveling when a motor inside the tube 105 is not operating and/or exerting a torque on the tube 105.

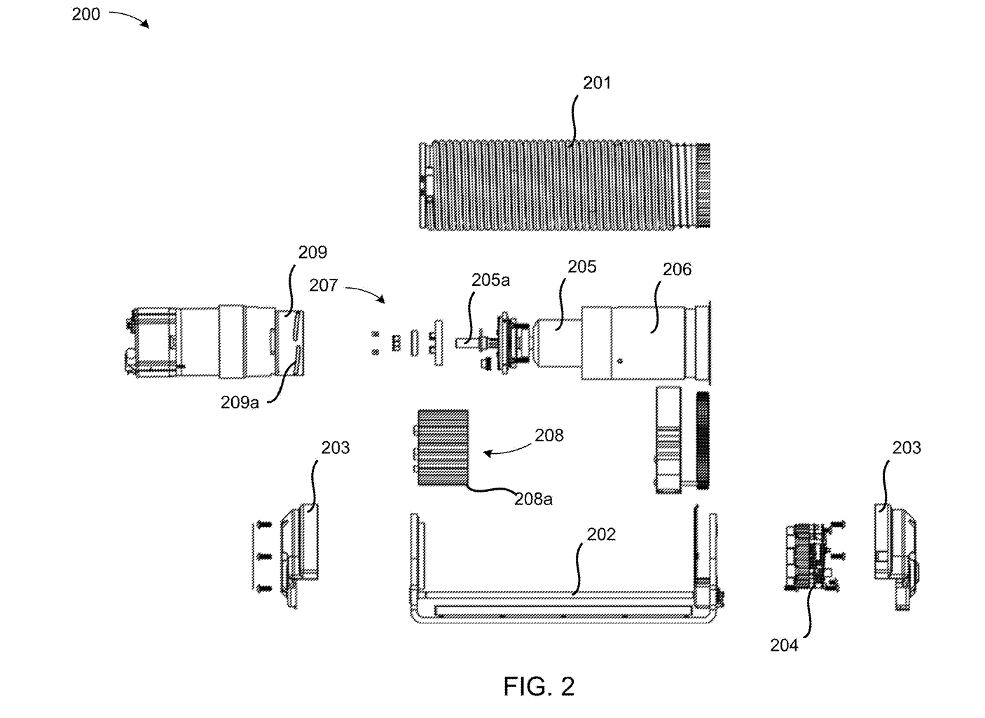

FIG. 2 depicts an exploded view of a winch incorporating a two-way output reverse-torque clutch. The winch 200 includes a drum 201, a support bracket 202, housing 203, control and communications electronics 204, a motor 205 having a rotor 205a, batteries 206, the clutch assembly 207, multi-stage planetary gear set 208, and a dual-stage shifter 209. The rotor 205a passes through the clutch assembly 207 and engages a sun gear of the planetary gear set 208. A ring gear 208a of the planetary gear set engages with an inner surface of the drum 201 to rotate the drum. Pins in tracks 209a convert rotary motion of the shifter 209 to lateral motion of the ring gear 208a, which locks and unlocks the stages of the planetary gear set 208.

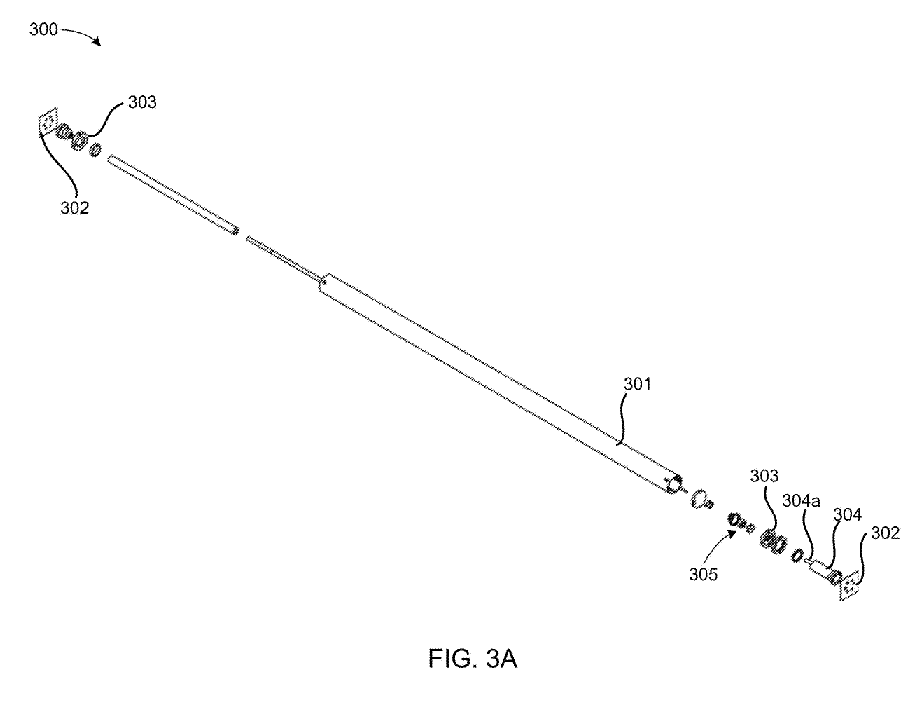

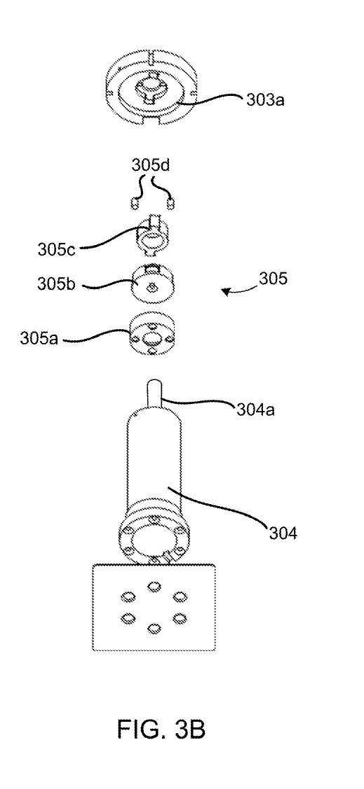

FIGS. 3A-B depict exploded views of a roll-up wall assembly incorporating a two-way output reverse-torque clutch. The roll-up wall assembly 300 includes a drum 301, mounting brackets 302, torque transmission rings 303, a motor 304 including a rotor 304a, and the clutch assembly 305. The rings are rotatably fixed to an inner surface of the tube, such that rotation of the rings translates into rotation of the tube. The rotor 304a engages the clutch assembly 305, and the clutch assembly 305 transmits torque from the rotor 304a to one of the torque transmission rings 303a. FIG. 3B depicts a zoomed-in view of the motor 304, the clutch assembly 305, and the ring 303a. The clutch assembly 305 includes an outer race 305a, a torque input 305b, a torque output 305c, and pins 305d. The rotor 304a passes through the clutch assembly 305 and the ring 303a. The ring 303a includes a seat 303b into which the torque output 305c fits. Thus, the torque output 305c directly transmits torque from the rotor 304a to the ring 303a.

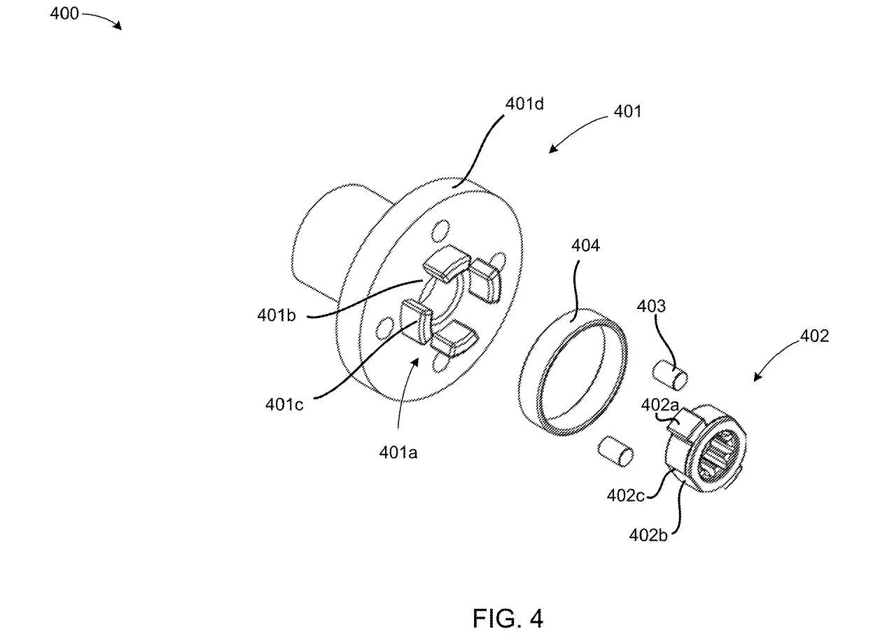

FIG. 4 depicts an exploded view of one two-way output reverse-torque clutch assembly embodiment. The assembly 400 includes a torque input 401, a torque output 402, pins 403, and an outer race 404. The torque input 401 includes a segmented race 401a, troughs 401b disposed between segments 401c of the segmented race 401a, and a base 401d from which the segments 401c extend. The torque output 402 includes fins 402a, a cam surface 402b, and an interference point 402c. The interference point may comprise a material harder than the pin. The interference point may comprise a hard material selected from the group consisting of tungsten carbide, cubic boron nitride, titanium carbide, titanium nitride, diamond, and diamond like carbon.

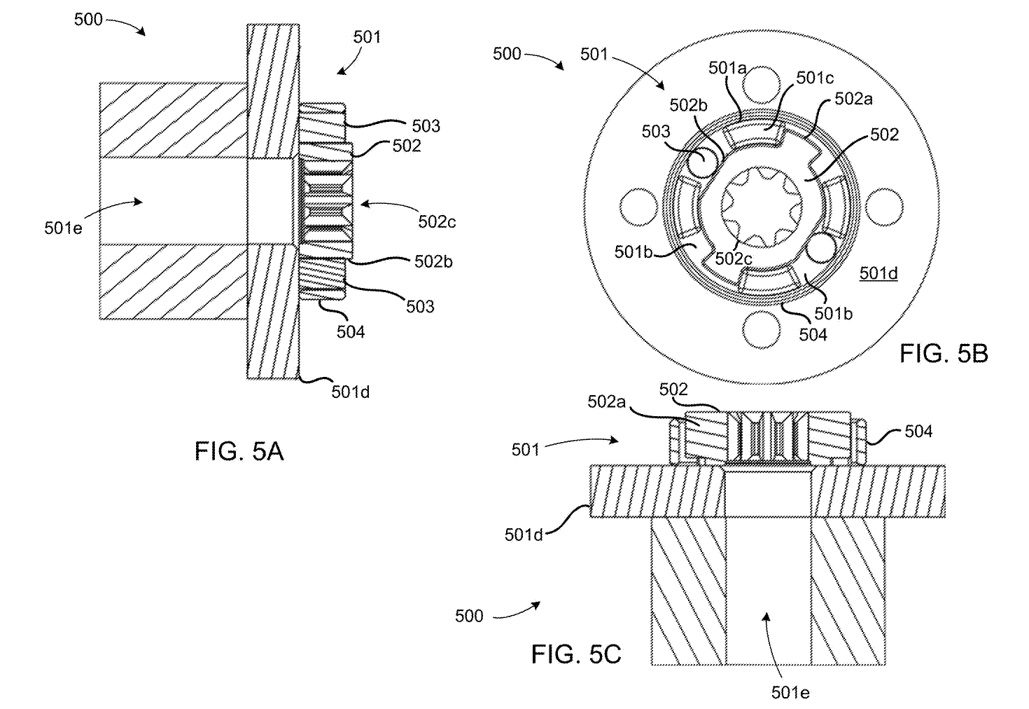

FIGS. 5A-C depict top and cross-sectional views of another two-way output reverse-torque clutch assembly embodiment. The assembly 500 includes a torque input 501, a torque output 502, pins 503, and an outer race 504. The torque input 501 includes a segmented race 501a, troughs 501b disposed between segments 501c of the segmented race 501a, a base 501d from which the segments 501c extend, and a hollow input shaft 501e. The input shaft 501e extends through the base 501d and away from the base 501d in a direction opposite the segmented race 501a. The torque output 502 includes fins 502a, a cam surface 502b, and a hollow output shaft 502c. The output shaft 502c extends through the torque output 502. The output shaft 502c and the input shaft 501e are concentric. The fins 502a sit in opposing troughs 501b, and the pins 503 sit in opposing troughs 501b. The pins 503 are disposed between the cam surface 502a and the outer race 504. Rotation of the torque output 502 reduces the width of the troughs 501b in which the pins 503 are disposed, pinning the pins 503 between the cam surface 502a and the outer race 504.

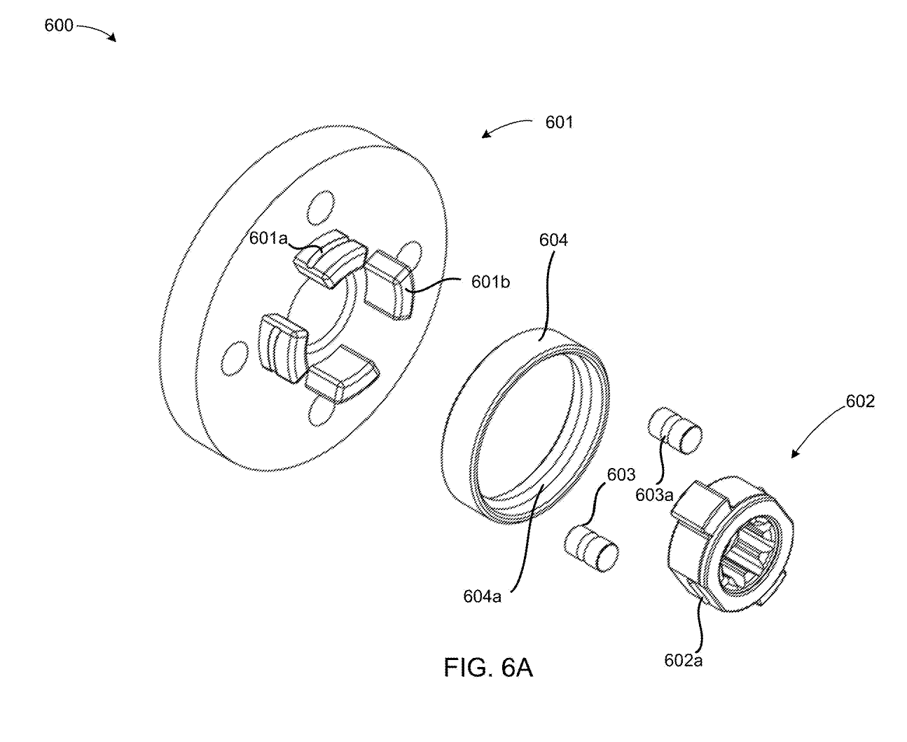

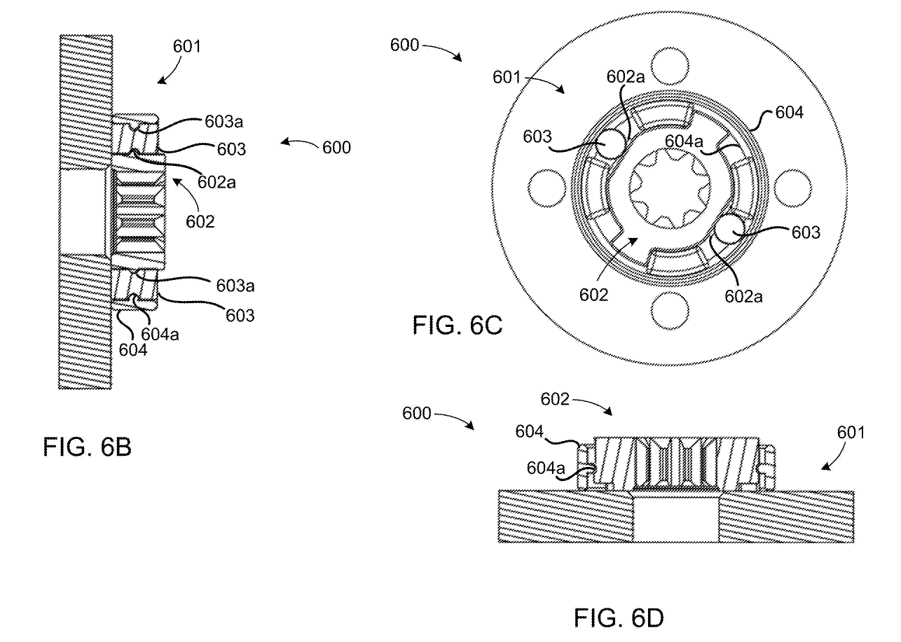

FIGS. 6A-D depict exploded, top and cross-sectional views of a two-way output reverse-torque clutch assembly embodiment. The assembly 600 includes a torque input 601, a torque output 602, pins 603, and an outer race 604. The assembly 600 includes other elements similar to those depicted in FIGS. 4 and 5A-C, which are not re-described here. The torque input 601 includes grooves 601a in the segmented race segments 601b. The torque output 602 includes runners 602a. The pins 603 include grooves 603a. The outer race 604 includes a runner 604a. The runners 602a, 604a sit in the grooves 601a, 603a. In some such embodiments, the outer race may initially include two segments that may be spot-welded, or otherwise bonded, together as the assembly 600 is assembled.

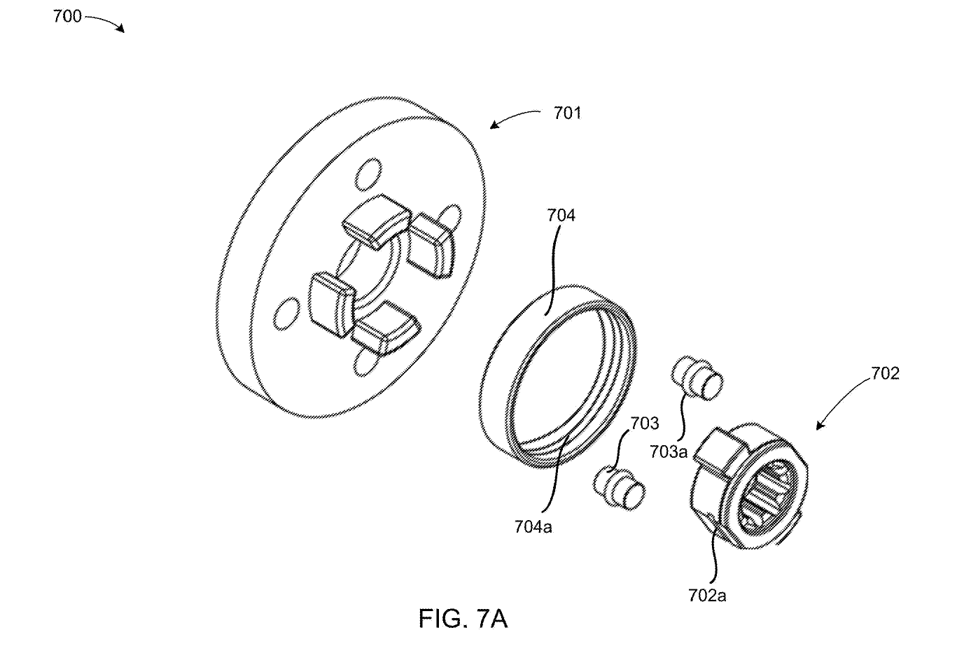

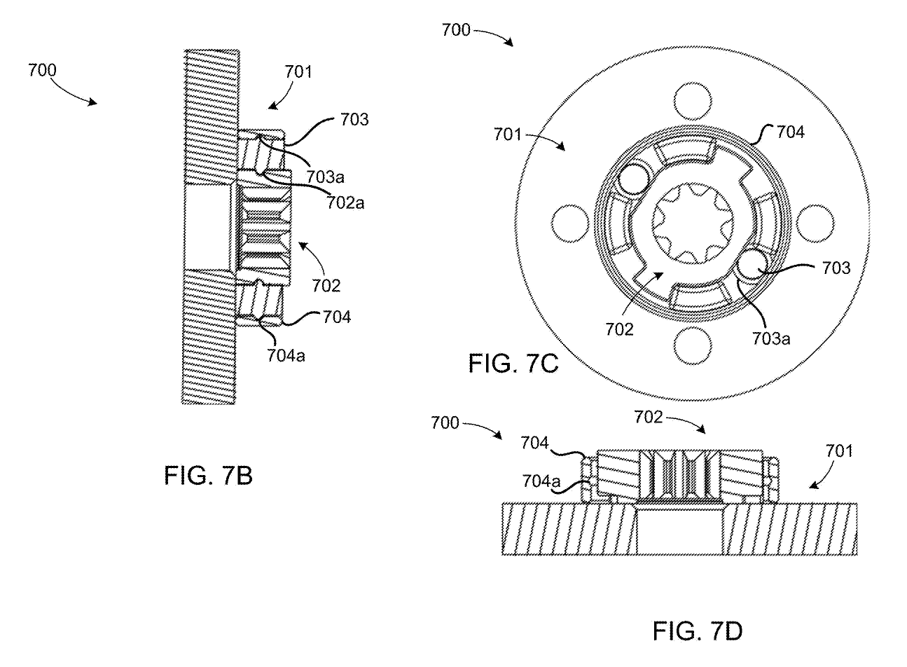

FIGS. 7A-D depict exploded, top and cross-sectional views of another two-way output reverse-torque clutch assembly embodiment. The assembly 700 includes a torque input 701, a torque output 702, pins 703, and an outer race 704. The assembly 700 includes other elements similar to those depicted in FIGS. 4 and 5A-C, which are not re-described here. The torque output 702 includes grooves 702a. The pins 703 include runners 703a. The outer race 704 includes a groove 704a. The runners 703a sit in the grooves 702a, 704a.

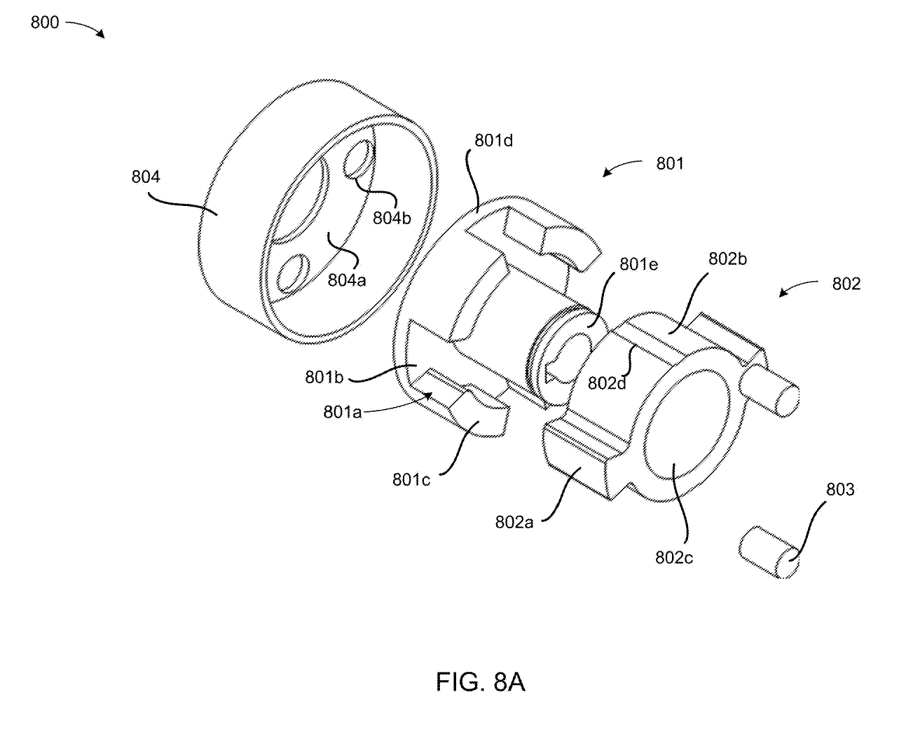

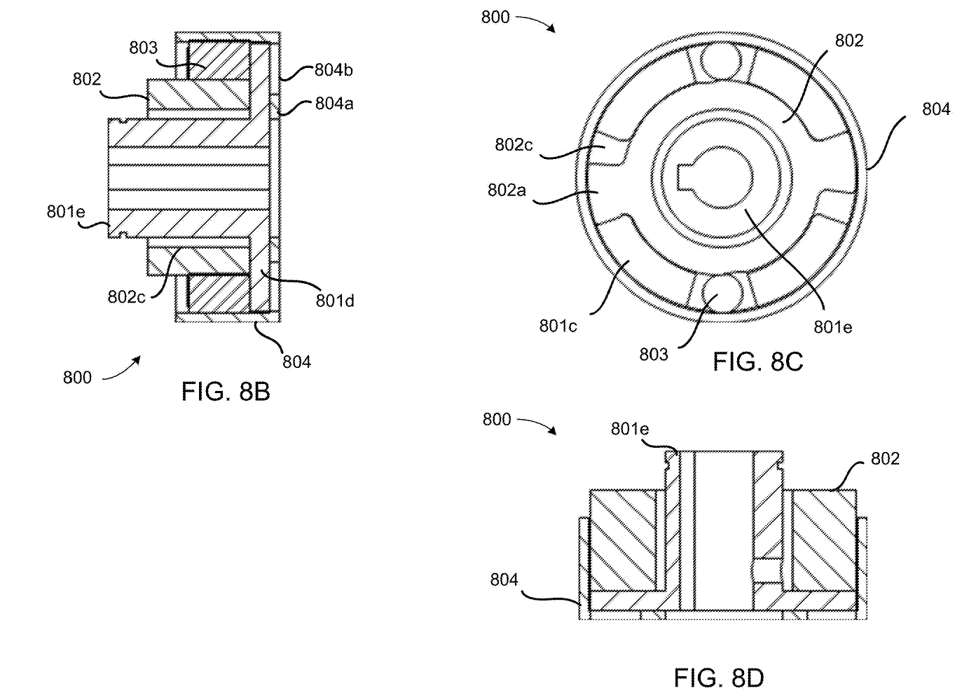

FIGS. 8A-D depict exploded, top and cross-sectional views of yet another two-way output reverse-torque clutch assembly embodiment. The assembly 800 includes a torque input 801, a torque output 802, pins 803, and an outer race 804. The torque input 801 includes a segmented race 801a, troughs 801b disposed between segments 801c of the segmented race 801a, a base 801d from which the segments 801c extend, and a hollow input shaft 801e. The input shaft 801e extends through the base 801d and away from the base 801d in the same direction as the segmented race 801a. The torque output 802 includes fins 802a, a cam surface 802b, a hollow output shaft 802c, and an interference point 802d. The interference point may comprise a material harder than the pin. The interference point may comprise a hard material selected from the group consisting of tungsten carbide, cubic boron nitride, titanium carbide, titanium nitride, diamond, and diamond like carbon.The output shaft 802c extends through the torque output 802. The output shaft 802c and the input shaft 801e are concentric. The input shaft 801 extends through the output shaft 802c, and has a length greater than a thickness of the torque output 802. The torque output 802 has a thickness greater than the segments 801c. The outer race 804 includes a backing 804a with openings 804b. Screws pass through the openings 804b and mount the outer race 804 to a motor and/or motor housing.

We claim:

1. A two-way output reverse-torque clutch, comprising:
a torque input comprising a segmented race;
a pin removably disposed adjacent to, and between, at least two segmented race segments;
an outer race encircling the segmented race and in slideable contact with the segmented race; and
a torque output rotatably disposed within the segmented race, the torque output comprising a cam surface having an interference point, wherein a torque exerted directly on the torque output forces the interference point against the pin, wedging the pin between the interference point and the outer race and preventing torque from being transmitted to the torque input from the torque output.

2. The two-way output reverse-torque clutch of claim 1, wherein a torque exerted on the output presses the pin between the cam surface and the outer race and prevents rotation of the output with respect to the outer race.

3. The two-way output reverse-torque clutch of claim 1, the torque input further comprising a base plate, wherein the segmented race is connected to, and extends from, the base plate.

4. The two-way output reverse-torque clutch of claim 3, wherein the base plate and segmented race are monolithic.

5. The two-way output reverse-torque clutch of claim 3, wherein the pin rests against the base plate.

6. The two-way output reverse-torque clutch of claim 3, wherein the torque output rests against the base plate.

7. The two-way output reverse-torque clutch of claim 3, wherein the outer race rests against the base plate.

8. The two-way output reverse-torque clutch of claim 3, the outer race further comprising a backing forming a cup enclosing the base plate.

9. The two-way output reverse-torque clutch of claim 8, the outer race further comprising one or more openings through the backing.

10. The two-way output reverse-torque clutch of claim 9, wherein the openings correspond to couplers that pass through the openings and couple the outer race to a motor housing.

11. The two-way output reverse-torque clutch of claim 1, the torque input further comprising a hollow input shaft extending through the torque input.

12. The two-way output reverse-torque clutch of claim 11, further comprising a base plate disposed between the input shaft and the segmented race, wherein the input shaft and the segmented race extend from the base plate in opposite directions.

13. The two-way output reverse-torque clutch of claim 12, wherein the input shaft has a narrower diameter than the base plate, the segmented race, or both.

14. The two-way output reverse-torque clutch of claim 11, the torque output further comprising a hollow output shaft extending through the torque output.

15. The two-way output reverse-torque clutch of claim 14, wherein the input shaft and output shaft are concentric.

16. The two-way output reverse-torque clutch of claim 14, wherein the input shaft extends through the output shaft.

17. The two-way output reverse-torque clutch of claim 1, wherein the pin comprises one or more grooves and wherein the outer race and the cam surface comprise one or more runners corresponding to, and disposed in, the grooves.

18. The two-way output reverse-torque clutch of claim 1, wherein the outer race and the cam surface comprise one or more grooves, and wherein the pin comprises one or more runners corresponding to, and disposed in, the grooves.

19. The two-way output reverse-torque clutch of claim 1, wherein the output has a thickness greater than a thickness of the input.

20. The two-way output reverse-torque clutch of claim 1, wherein at least the interference point comprises a material harder than the pin.
